(19) United States
(12) Patent Application Publication
(10) Pub. No.: US 2026/0361740 A1
(43) Pub. Date: Nov. 12, 2026

(54) Reviewing Artificial Intelligence (AI) Prompts and Outputs to Identify Malicious Behavior

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US); Manish Marwah, Pleasonton, CA (US)

(73) Assignee: MICRO FOCUS LLC, WILMINGTON, DE (US)

(21) Appl. No.: 19/656,645

(22) Filed: Apr. 23, 2026

Related U.S. Application Data
(63) Continuation of application No. 18/769,346, filed on Jul. 10, 2024, now abandoned.

(51) Int. Cl. H04L 9/40

(52) U.S. Cl. CPC H04L 63/1425

(57) ABSTRACT

A prompt monitoring Artificial Intelligence (AI) algorithm monitors AI prompts provided to an AI algorithm and/or AI outputs from the AI algorithm that are generated in response to the AI prompts provided to the AI algorithm. The prompt and output monitoring AI algorithm identifies an anomalous AI prompt provided to an AI algorithm and/or an anomalous AI output from the AI algorithm. For example, an anomalous AI prompt may be a prompt to create malware in source code. In response to identifying the anomalous AI prompt provided to the AI algorithm and/or the anomalous AI output from the AI algorithm, an action is taken that is associated with the identified anomalous AI prompt provided to the AI algorithm and/or the anomalous AI output from the AI algorithm. For example, the action may be to unload the AI algorithm or block the anomalous AI prompt provided to the AI algorithm.

### FIELD

The disclosure relates generally to AI algorithms and particularly to detection of anomalous behavior associated with AI algorithms.

### BACKGROUND

With the advent of Artificial Intelligence (AI), AI is becoming pervasive in many computer systems. Because of the increased proliferation of AI algorithms, AI algorithms are now being targeted by malicious parties. If an AI algorithm can be compromised, a hacker may be able to hack various computer systems that rely on the AI algorithm. This can result in security breaches in computer networks and computer systems.

### SUMMARY

These and other needs are addressed by the various embodiments and configurations of the present disclosure. The present disclosure can provide a number of advantages depending on the particular configuration. These and other advantages will be apparent from the disclosure contained herein.

A prompt monitoring Artificial Intelligence (AI) algorithm monitors AI prompts provided to an AI algorithm and/or AI outputs from the AI algorithm that are generated in response to the AI prompts provided to the AI algorithm. The prompt and output monitoring AI algorithm identifies an anomalous AI prompt provided to an AI algorithm and/or an anomalous AI output from the AI algorithm. For example, an anomalous AI prompt may be a prompt to create malware in source code. In response to identifying the anomalous AI prompt provided to the AI algorithm and/or the anomalous AI output from the AI algorithm, an action is taken that is associated with the identified anomalous AI prompt provided to the AI algorithm and/or the anomalous AI output from the AI algorithm. For example, the action may be to unload the AI algorithm or block the anomalous AI prompt provided to the AI algorithm. Another example is where the output is unrelated to the task of the AI algorithm. An example is where the AI algorithm was trained on product documentation but is asked to output a joke or harmful language.

The phrases "at least one", "one or more", “or,” and "and/or" are open-ended expressions that are both conjunctive and disjunctive in operation. For example, each of the expressions "at least one of A, B and C", "at least one of A, B, or C", "one or more of A, B, and C", "one or more of A, B, or C", "A, B, and/or C", and "A, B, or C" means A alone, B alone, C alone, A and B together, A and C together, B and C together, or A, B and C together.

The term "a" or "an" entity refers to one or more of that entity. As such, the terms "a" (or "an"), "one or more" and "at least one" can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficulty level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

When discussing a change to sources of AI prompts to an AI algorithm and/or destinations of AI outputs from the AI algorithm herein and in the claims, a change may include adding a new source, adding a new destination, changing a source from one source to another, changing a destination from one destination to another, removing a source, removing a destination, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for reviewing AI prompts to identify anomalous behavior.

FIG. 2 is a block diagram of a second illustrative system for reviewing AI prompts to identify anomalous behavior.

FIG. 3 is a block diagram of a third illustrative system for reviewing AI prompts using a vector AI algorithm.

FIG. 4 is a block diagram of a fourth illustrative system for reviewing AI prompts to identify anomalous behavior.

FIG. 5 is a flow diagram of a process for reviewing AI prompts to identify anomalous behavior.

FIG. 6 is a flow diagram of a process for determining data associated with anomalous AI prompts to an AI algorithm, anomalous AI outputs from an AI algorithm, anomalous sources to an AI algorithm, and/or anomalous destinations from an AI algorithm.

FIG. 7 is a flow diagram of a process for identifying AI algorithms within applications, identifying sources of AI prompts to the AI algorithms, and identifying destinations of the AI outputs.

FIG. 8 is a diagram of a user interface for managing anomalous information associated with an AI algorithm.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

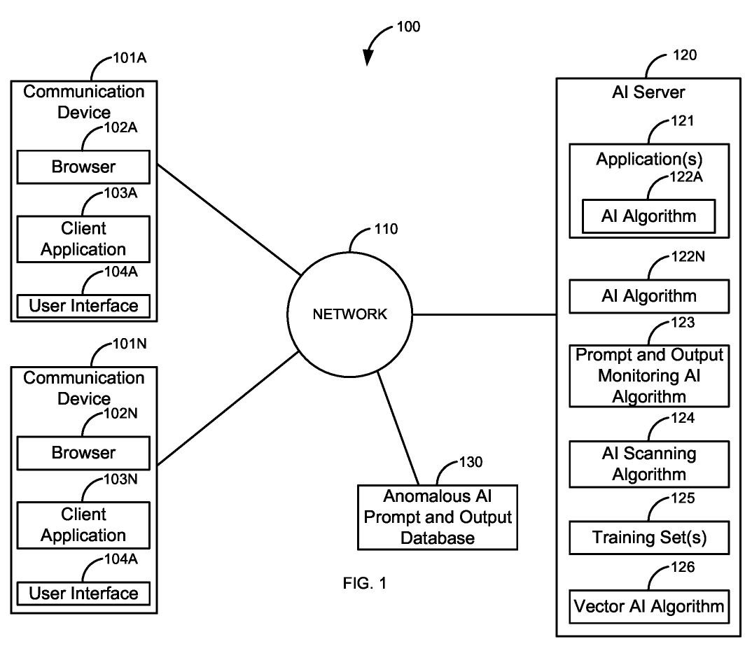

FIG. 1 is a block diagram of a first illustrative system 100 for reviewing AI prompts to identify anomalous behavior. The first illustrative system 100 comprises communication devices 101A-101N, a network 110, an AI server 120, and an anomalous AI prompt and output database 130.

The communication devices 101A-101N can be or may include any user device that can communicate on the network 110, such as a Personal Computer (PC), a cellular telephone, a Personal Digital Assistant (PDA), a tablet device, a notebook device, laptop computer, a smartphone, and the like. The communication devices 101A-101N allow a user to access the AI server 120/AI algorithms 122A-122N. As shown in FIG. 1, any number of communication devices 101A-101N may be connected to the network 110, including only a single communication device 101. The communication devices 101A-101N further comprise browsers 102A-102N, client applications 103A-103N, and user interfaces 104A-104N.

The browsers 102A-102N can be or may include any browser 102 that can browse an application 121 and/or access an AI algorithm 122 on the AI server 120. For example, the browsers 102A-102N may be a Chrome® browser, a Microsoft Edge ® browser, a Safari ® browser, a Firefox ® browser, and/or the like.

The client applications 103A-103N are applications that work with the application(s) 121. The client applications 103A-103N are client/server client applications. For example, the client applications 103A-103N may be a software application this is designed to specifically work with the application 121.

The user interfaces 104A-104N are interfaces that allow the user to visually use the browsers 102A-102N/client applications 103A-103N to access the application(s) 121/AI algorithms 122A-122N on the AI server 120. The user interfaces 104A-104N may be used to visually view anomalous behavior of the AI algorithms 122A-122N. The user interfaces 104A-104N may be a Light Emitting Diode (LED) display, a plasma display, a cathode ray tube display, and/or the like.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), WiFi, Hyper Text Transfer Protocol (HTTP), Web Real-Time Protocol (Web RTC), and/or the like. Thus, the network 110 is an electronic communication network configured to carry messages via packets and/or circuit switched communications.

The AI server 120 can be or may include any hardware coupled with firmware/software that can be used to host the AI algorithms 122A-122N. The AI server 120 further comprise the application(s) 121, the AI algorithms 122A-122N, the prompt and output monitoring AI algorithm 123, the AI scanning algorithm 124, the training set(s) 125, and the vector AI algorithm 126.

The application(s) 121 can be or may include any firmware/software application 121 that comprises an AI algorithm(s) 122. The application(s) 121 can be any type of application, such as a web application, a security application, a cloud service, a networked application, a financial application, a database, and/or the like. An application 121 may be an AI algorithm 122. The application(s) 121 may be located on the AI server 120 and/or at other locations on the network 110. In FIG. 1, the application(s) 121 comprises the AI algorithm 122A.

The AI algorithms 122A-122N can be any type of AI algorithm 122, such as a machine learning algorithm, a neural network, a Generative Adversarial Network (GAN), a narrow AI, a general AI, a super AI, a reactive machine, a limited memory AI, a self-aware AI, and/or the like. The AI algorithms 122A-122N may be part of the application(s) 121, part of a library that the application(s) 121 use, part of a binary called by the application(s) 121, in source code that is interpreted by an interpreter, and/or the like.

The prompt and output monitoring AI algorithm 123 is an AI algorithm 122 that is trained based on AI prompts/AI outputs from the AI algorithms 122A-122N. The prompt and output monitoring AI algorithm 123 may use unsupervised machine learning to determine normal AI prompts/AI outputs from the AI algorithms 122A-122N or may use the training set 125 (e.g., using a supervised learning AI algorithm 122).

The AI scanning algorithm 124 is an AI algorithm 122 that is trained to identify different kinds of AI algorithms 122. For example, the AI scanning algorithm 124 may be trained on a variety of types of AI algorithms 122/structures of AI algorithms 122 to learn patterns that make up the AI algorithm 122 in source code and/or in binaries. In addition, the AI scanning algorithm 124 is trained to identify the source code/binary code where AI prompt(s) are provided to the AI algorithm 122 and a location where the AI outputs from the AI algorithm 122 are generated.

The training set(s) 125 may be used by the prompt and output monitoring AI algorithm 123 to learn normal prompt behavior/output behavior of AI algorithms 122. The training set 125 may be optional for the prompt and output monitoring AI algorithm 123. For example, if unsupervised machine learning is used, the prompt and output monitoring AI algorithm 123 may not use the training set 125.

The training set 125 may comprise multiple training sets 125. For example, one training set 125 may be used to train the prompt and output monitoring AI algorithm 123 and another training set 125 may be used to train the AI scanning algorithm 124. The training set 125 for the AI scanning algorithm 124 may comprise source code of different types of AI algorithms 122, binaries of different types of AI algorithms 122, and/or the like.

The vector AI algorithm 126 is a type of prompt and output monitoring AI algorithm 123 that uses vectors. The vector AI algorithm 126 compares vectors of the AI prompts/AI outputs to known/learned vectors of AI prompts/AI outputs. The comparison may be for anomalous AI prompts/anomalous output.

The anomalous AI prompt database 130 comprise anomalous AI prompts that are captured by the prompt and output monitoring AI algorithm 123. The anomalous prompt database 130 may also comprise anomalous outputs from different AI algorithms 122. The anomalous AI prompts/anomalous AI outputs may come from multiple prompt monitoring AI algorithms 123. For example, the anonymous AI prompts/AI outputs may come from different prompt monitoring AI algorithms 123 that are on different networks owned by different entities. Another example may be where the prompts are unrelated to what the AI algorithm 122 is trained on.

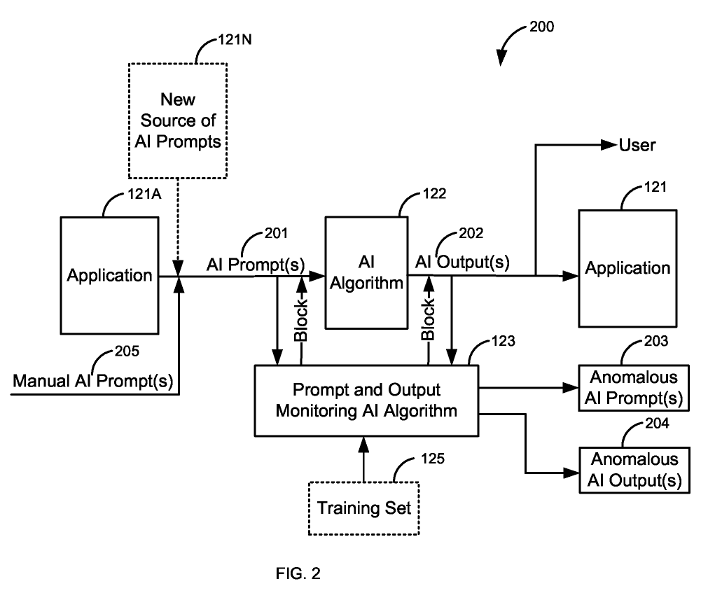

FIG. 2 is a block diagram of a second illustrative system 200 for reviewing AI prompts 201 to identify anomalous behavior. The second illustrative system 200 comprises the applications 121A/121N, the AI algorithm 122, the prompt and output monitoring AI algorithm 123, the training set 125, AI prompt(s) 201, AI output(s) 202, anomalous AI prompt(s) 203, anomalous AI output(s) 204, and manual prompt(s) 205.

The prompt and output monitoring AI algorithm 123 monitors, in real-time, AI prompt(s) 201 that are provided to an AI algorithm 122 to identify anomalous AI prompt(s) 203/ anomalous AI output(s) 204. The AI prompt(s) 201 may include AI prompts 201 that are manual prompt(s) 205, AI prompt(s) 201 that come from an existing application 121A, and/or prompts that come from a new application 121N (a new source of AI prompts 201).

The prompt and output monitoring AI algorithm 123 may use unsupervised machine learning (or could use supervised/semi-supervised machine learning) to learn the normal behavior of AI prompt(s) 201 and the corresponding normal AI output(s) 202 that are generated from the normal AI prompt(s) 201. This allows the prompt and output monitoring AI algorithm 123 to identify anomalous AI prompt(s) 203 and/or anomalous AI output(s) 204. An example could be where a malicious program has hacked the application 121A that provides the AI prompt(s) 201 to the AI algorithm 122 and the AI algorithm 122 is now providing anomalous AI prompt(s) 203 in place of or in conjunction with existing AI prompts 201 to cause bias in the AI output 202 of the AI algorithm 122. For example, the bias may cause a software system (e.g., application 121) to become compromised.

If anomalous AI prompt(s) 203 are identified, the AI output 202 of the AI algorithm 122 may be captured to identify how the anomalous prompts 203 are affecting the AI output 202 of the AI algorithm 122 versus normal learned AI prompt(s) 201/normal AI output 202. Another example could be where the AI algorithm 122 has been compromised and is now outputting anomalous output(s) 204 (even though the AI prompt(s) 201 are not anomalous). The identified anomalous AI prompt(s) 203/anomalous AI output(s) 204 can be provided to a security analyst in a user interface 104.

How the prompt and output monitoring AI algorithm 123 detects the anomalous AI prompt(s) 203/anomalous AI output(s) 204 can be done in various ways. In one embodiment, the system may monitor software function calls to the input of the AI algorithm 122. For example, when the application 121A is first installed, the system identifies what code in the application 121A initially calls the AI algorithm 122 to provide the AI prompt(s) 201. If, at a later point in time, a new source is identified as providing input to the AI algorithm 122 this can be flagged (e.g., from the application 121N). The AI prompt(s) 201 to the AI algorithm 122 may be monitored by hooking the source code that is used to input the prompts to the AI algorithm 122.

For example, a change of source may be where function A originally called the AI algorithm 122 to provide the AI prompt(s) 201 and now function A calls function B (an inserted malware) and then function B now calls the AI algorithm 122, this type of behavior can be flagged as anomalous behavior where a source of the AI prompts 201 has changed. The anomalous source code/function call can be identified along with the anomalous AI prompt(s) 203/ anomalous AI output(s) 204.

In addition to sources, changes to the destinations of the AI output(s) 204 may be identified. For example, if a new destination of the AI output(s) is identified (e.g., a different or new application, this can be flagged to a security analyst.

Another way to detect anomalous AI prompt(s) 203 is that the prompt and output monitoring AI algorithm 123 may look for a large number of AI prompts 201 within a time period versus a normal amount in a similar time period. For example, if one hundred thousand AI prompts 201 are received in a minute where only a maximum of two thousand AI prompts 201 were previously received in the same time period, this may be flagged as an anomaly. Likewise, if the number of AI prompts 201 goes down significantly from normal, this could be identified as an anomaly. These types of anomalous behaviors could be helpful in identifying new types of attacks against the AI algorithm 122. For example, if the number of AI prompts 201 increased to the one hundred thousand AI prompts 201 in a minute, this may be a denial-of-service attack to overload the AI algorithm 122.

Another anomalous behavior may be where a size of the AI output 202 is different from previous AI outputs 202. For example, if the size of the AI output 202 is twice as large as previously learned, this can be identified.

How the anomalous behavior is handled may work in various ways, such as quarantining an application 121, removing malware from source code, killing a thread, unloading an application 121, removing malware from the AI algorithm 122, removing a source of AI prompts, blocking the anomalous AI prompt(s) 203, blocking the anomalous AI output(s) 204, and/or the like. How anomalous behavior is managed may be administered.

Another example may be where a user is providing anomalous AI prompts 201 that are malicious (manual prompts 205). In this case, the user may be identified along with the anomalous AI prompts 203/anomalous AI output 204. If malicious/anomalous use is identified, the user may be blocked, the anomalous AI prompt(s) 203 may be blocked, and the anomalous AI output(s) 204 may be blocked, and/or the like. Information about the anomalous AI prompts 203/anomalous AI output(s) 204 may be captured along with other relevant context information, such as, the anomalous prompt(s) 203, the anomalous AI output 204, time information, source/application 121 making the anomalous AI prompt(s) 203, and/or the like.

In addition, the system may look for any known malicious/anomalous AI prompts 203 that have been previously captured. For example, a previously known malicious anomalous AI prompt 203 (may be tied to a specific AI algorithm 122) may be stored in the anomalous AI prompt and output database 130 along with the associated AI algorithm 122. The anomalous AI prompt and output database 130 may contain anomalous AI prompts 203/anomalous AI outputs 204 captured from multiple networks (e.g., multiple different corporate networks).

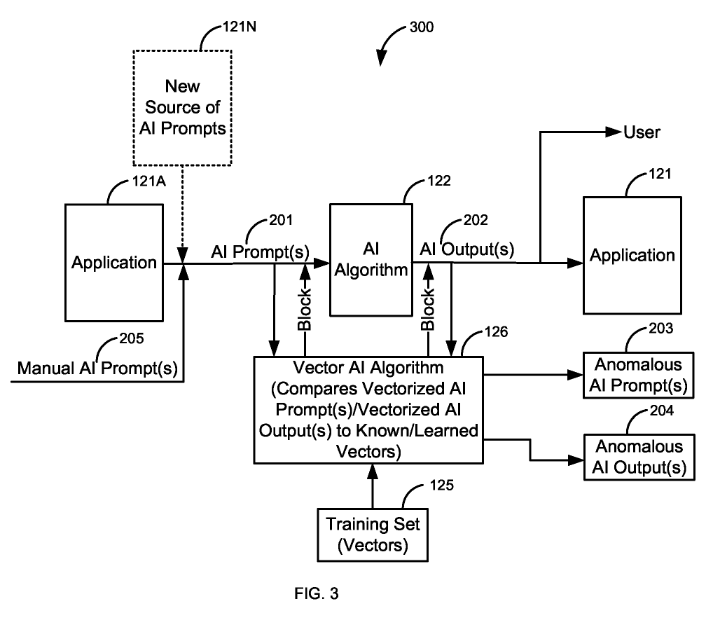

FIG. 3 is a block diagram of a third illustrative system for reviewing AI prompts 201 using a vector AI algorithm 126. The primary difference between FIGS. 2 and 3 is that the prompt and output monitoring AI algorithm 123 is a vector AI algorithm 126. The vector AI algorithm 126 takes the AI prompt(s) 201/AI output(s) 202 and vectorizes the AI prompts 201/AI output(s) 202. For example, the vector AI algorithm 126 may create floating point vectors/integer vectors that can be clustered into groups to identify anomalous AI prompt(s) 203/anomalous AI output(s) 204. The floating-point/integer vectors can be clustered into groups of acceptable AI prompt(s) 201.

The vectorization can also help to identify anomalous AI prompts 203 that are out-of-scope. An out-of-scope anomalous AI prompt 203 may be an AI prompt 201 that is out of scope from the training set 125 used to train the AI algorithm 122. The vector AI algorithm 126 compares the vectorized AI prompts/vectorized AI outputs to previous vectorized AI prompts/vectorized AI outputs (normal state).

If an anomalous AI prompt 203 is identified by the vector AI algorithm 126, the vector AI algorithm 126 can block the anomalous AI prompt(s) 203 to the AI algorithm 122. The blocking may only apply to a specific AI prompt 201. For example, there may be three AI prompts 201, where only one of the three AI prompts 201 is an anomalous AI prompt 203 that is blocked by the vector AI algorithm 126. The vector AI algorithm 126 may also block the anomalous AI output(s) 204.

How the vector AI algorithm 126 vectorizes the AI prompts 201/AI outputs 202 may vary based on implementation. For example, the vector AI algorithm 126 may break the AI prompts 201/AI outputs 202 into specific size chunks that are then vectorized. Alternatively, the complete AI prompts 201/AI outputs 202 may be vectorized. The size of the chunks may be based on the type of AI algorithm 122/memory capacity of the AI algorithm 122.

If vectorization is used, the information stored in the anomalous AI prompt and output database 130 may also be vectorized anomalous AI prompts/vectorized anomalous AI outputs. The vectorized anomalous AI prompts/vectorized anomalous AI outputs stored in the anomalous AI prompt and output database 130 may be used to identify anomalous AI prompts 203/anomalous AI outputs 204. One key advantage to the vectorization is that the process to identify anomalous AI prompt(s) 203/anomalous AI output(s) 204 is much more efficient.

Different AI models may be used for converting AI prompts 201/AI outputs 202 to vectors. These include autoencoders, BERT-based embedding models, and/or the like. The size of the vectors depends on the models used.

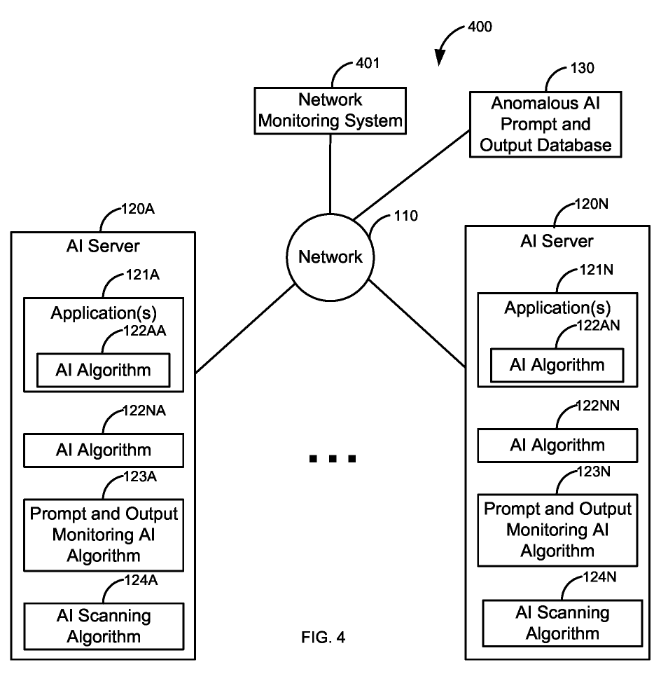

FIG. 4 is a block diagram of a fourth illustrative system 400 for reviewing AI prompts 201 to identify anomalous behavior. The fourth illustrative system 400 comprises the network 110, AI servers 120A-120N, the anomalous AI prompt and output database 130, and a network monitoring system 401.

The network monitoring system 401 can be or may include any hardware coupled with software that can be used to monitor the network 110 for anomalous behavior of the AI algorithms 122AA, 122NA, 122AN, and 122NN. The network monitoring system 401 may be used by a security analyst/administrator to monitor and make updates to the AI servers 120A-120N/AI algorithms 122AA, 122NA, 122AN, and 122NN.

The AI scanning algorithms 124A-124N can scan the source code/binaries of the applications 121A-121N for known or new AI algorithms 122AA, 122NA, 122AN, and 122NN. New AI algorithm(s) 122 may be identified using the AI scanning algorithms 124A-124N that have been trained using known AI algorithms 122 (e.g., patterns/signatures) to identify existing and new AI algorithms 122 that were previously unknown. The identified AI algorithms 122 can then be monitored for anomalous behavior in the AI prompts 201/AI outputs 202. In addition, the identified AI algorithms can be monitored for changes in sources of the AI prompts 201 (also could be a change in a destination of the AI outputs 202). Once the AI algorithms 122 are identified, the prompt and output monitoring AI algorithm 123 may scan the identified AI algorithms 122 to identify anomalous AI prompts 203/anomalous AI outputs 204 that vary from normal prompts/AI output 202. This process can be repeated in the network 110 to identify all the AI algorithms 122 being used in the network 110. The network monitoring system 401 can then be used to collect any anomalous AI prompt data/AI output data/source data from each of the AI algorithms 122 along with other associated anomalous data.

The anomalous AI prompts 203, anomalous AI outputs 204, anomalous sources, and/or anomalous destinations can also be tied to existing anomaly detections systems to better diagnose problems. For example, the anomalous AI prompts 203, anomalous AI outputs 204, anomalous sources, and/or anomalous destinations can be tied with network traffic generation, login results, connections made, log entries, etc. that result from or are associated the anomalous AI prompts 203, anomalous AI outputs 204, anomalous sources, and/or anomalous destinations.

Information associated with the anomalous AI prompts 203 may be stored in a blockchain/distributed ledger. For example, the anomalous AI prompts 203 may be stored in an anonymous prompt block in a blockchain/distributed ledger.

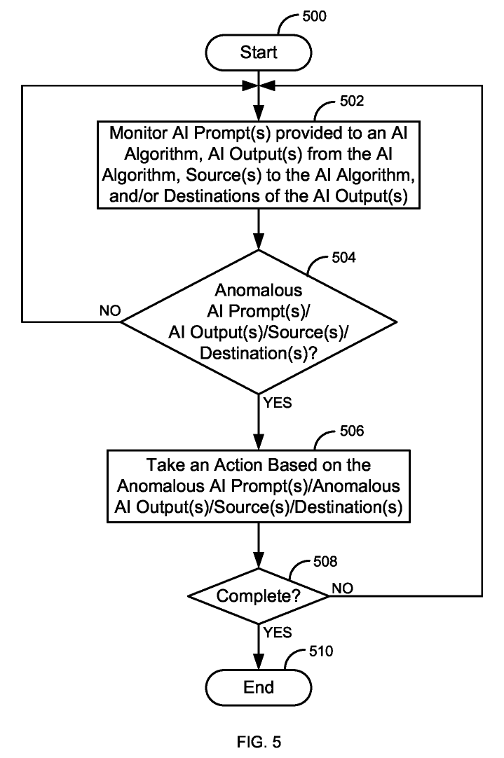

FIG. 5 is a flow diagram of a process for reviewing AI prompts 201 to identify anomalous behavior. Illustratively, the communication devices 101, the browsers 102, the client applications 103, the user interfaces 104, the AI servers 120, the applications 121, the AI algorithms 122, the prompt and output monitoring AI algorithm 123, the AI scanning algorithm 124, the training set(s) 125, the vector AI algorithm 126, the anomalous AI prompt and output database 130, and the network monitoring system 401 are stored-program-controlled entities, such as a computer or microprocessor, which performs the method of FIGS. 4-8 and the processes described herein by executing program instructions stored in a computer readable storage medium, such as a memory (i.e., a computer memory, a hard disk, and/or the like). Although the methods described in FIGS. 4-8 are shown in a specific order, one of skill in the art would recognize that the steps in FIGS. 4-8 may be implemented in different orders and/or be implemented in a multi-threaded environment. Moreover, various steps may be omitted or added based on implementation.

The process starts in step 500. The prompt and output monitoring AI algorithm 123 monitors AI prompt(s) 201 provided to the AI algorithm 122, AI output(s) 202 from the AI algorithm 122, source(s) to the AI algorithm 122, and/or destinations from the AI algorithm 122 in step 502. The prompt and output monitoring AI algorithm 123 determines, in step 504, if any anomalous AI prompt(s) 203, anomalous AI output(s) 204, anomalous source(s), and/or anomalous destination(s) have been identified. If there are no anomalous AI prompts 203, anomalous AI output(s) 204, anomalous source(s), and/or anomalous destination(s) identified in step 504, the process goes back to step 502. Otherwise, if there are any anomalous AI prompt(s) 203, anomalous AI output(s) 204, anomalous source(s), and/or anomalous destination(s) identified in step 504, an action is taken, in step 506. For example, the action may be to notify a security analyst that a source of the AI prompts 201 has changed.

The process determines, in step 508, if the process is complete. If the process is not complete in step 508, the process goes back to step 502. Otherwise, the process ends in step 510. The process of FIG. 5 may be done in real-time, semi real-time, in batch mode, and/or the like.

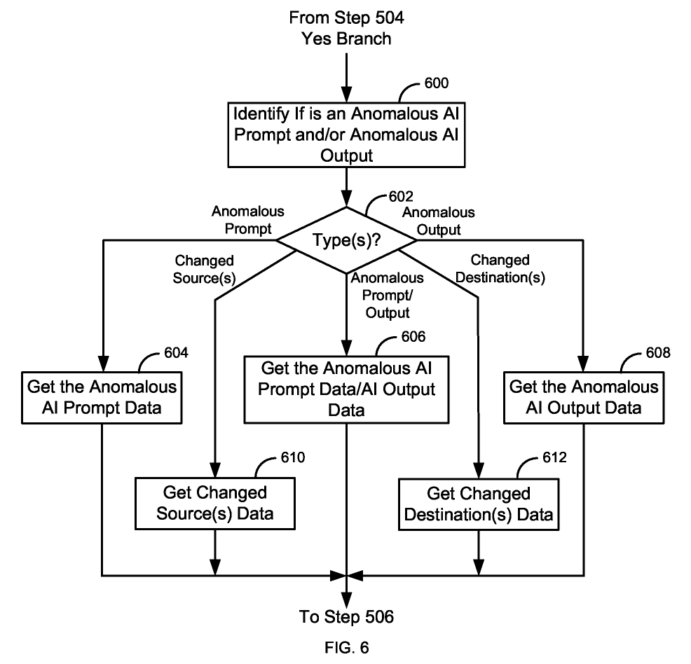

FIG. 6 is a flow diagram of a process for determining data associated with anomalous AI prompts 203 to an AI algorithm 122, anomalous AI outputs 204 from an AI algorithm 122, anomalous sources to an AI algorithm, and/or anomalous destinations from an AI algorithm 122. The process of FIG. 6 goes between steps 504 (yes branch) and step 506 of FIG. 5.

After identifying the anomalous AI prompt(s) 203, the anomalous AI output(s) 204, the anomalous source(s), and/or the anomalous destination(s) in step 504, the prompt and output monitoring AI algorithm 123 determines the identified type(s) in step 600.

If the type is an anomalous AI prompt(s) 203 where the AI output 202 is not an anomalous AI output(s) 204 in step 602, the prompt and output monitoring AI algorithm 123 gets the anomalous AI prompt data in step 604 and the process goes to step 506. The anomalous AI prompt data may be any information associated with the anomalous AI prompt(s) 203 such as, the anomalous AI prompt(s) 203, information associated with the AI algorithm 122, a source of the anomalous AI prompt(s) 203, a time of the anonymous AI prompt(s) 203, a user associated with the anomalous AI prompt(s) 203, and/or the like.

If the type is an anomalous prompt(s) 203 and an anomalous AI output 204 in step 602, the prompt and output monitoring AI algorithm 123 gets the anomalous AI prompt data and the anomalous AI output data in step 606 and the process goes to step 506. The anomalous AI prompt data may be similar to what was described above. The anomalous AI output data may be any information associated with the anomalous AI output(s) 204 such as, the anomalous AI output(s) 204, information associated with the AI algorithm 122, a time of the anonymous AI output(s) 204, and/or the like.

If the type is the anomalous AI output(s) 204 (e.g., the AI prompt(s) 201 is not anomalous), in step 602, the prompt and output monitoring AI algorithm 123 gets the anomalous output data in step 608 and the process goes to step 506. For example, the AI prompt 201 may not be anomalous, but the AI output 202 is an anomalous AI output 204 (e.g., the AI algorithm 122 has been hacked and is generating anomalous AI output 204).

If type is the changed source(s) in step 602, data about the changed source(s) of the AI prompt(s) 201 is identified in step 610 and the process goes to step 506. For example, if the new anomalous source is a new application 121, the new application 121 can be identified, a time/date of the change of the source, a version of the new application 121, and/or the like may be gathered in step 610. A changed source may be identified where the source code/binary is changed. For example, a new function call may be made to the input of the AI algorithm 122, this can be flagged as an anomaly. The process of identifying changes to sources(s) may be done in real-time.

If the type is the changed destination(s) in step 602, data about the changed destination(s) is identified in step 612 and the process goes to step 506. For example, if the new destination is a new application 121, the new application 121 can be identified, a time/date of the change of the destination, a version of the new application 121, and/or the like may be gathered in step 612. A changed destination may be identified where the source code that takes the AI output 202 has changed. For example, if the source code that produces the AI output 202 has changed to a different application 121 or now goes to two different applications 121, this can be flagged as an anomaly. An example may be where the new destination is a nefarious destination that takes the AI output 202 and sends it to a nefarious location. The process of identifying changes to destination(s) may be done in real-time.

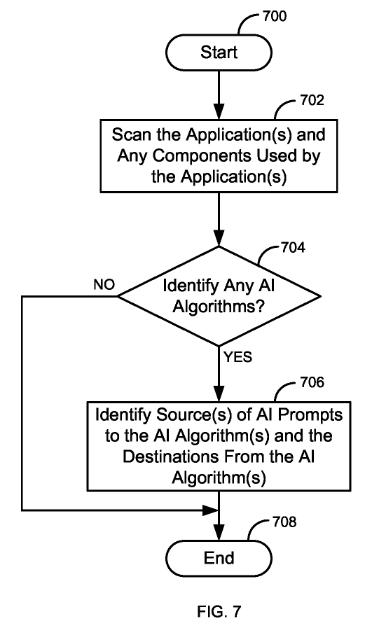

FIG. 7 is a flow diagram of a process for identifying AI algorithms 122 within applications 121, identifying sources of AI prompts 201 to the AI algorithms 122, and identifying destinations of the AI outputs 202. The process starts in step 700.

The AI scanning algorithm 124 scans the application(s) 121 and any component(s) used by the application(s) 121 in step 702. The scanning may be done on source code that is interpreted and/or in binary file(s). The component(s) may include libraries or other executables called by the application(s) 121. The scanning may include scanning the client application(s) 103. The AI scanning algorithm 124 identifies any AI algorithm(s) 122 in the application(s) 121 in step 704. An application 121 may be a stand-alone AI algorithm 122. If there are not any identified AI algorithms 122 in step 704, the process goes to step 708 and ends.

Otherwise, if any AI algorithms 122 are identified in step 704, the AI scanning algorithm 124 identifies source(s) of the AI prompts 201 and the destination(s) from the AI algorithm 122 in step 706. The AI scanning algorithm 124 can identify sources of the AI prompt(s) 201 in step 706 in various ways, such as identifying function calls that provide the AI prompt(s) 201, identifying an application 121 that provides the AI prompt(s) 201 to the AI algorithm 122, identify a user interface 104 that allows a user to enter manual AI prompts 205 into the AI algorithm 122, and/or the like. The AI scanning algorithm 124 may identify the destination(s) from the AI algorithm 122 in various ways, such as by identifying data returned from a function call (e.g., a function call that provides the AI prompt(s) 201 and returns the AI output 202). Once the sources of the AI prompt(s) 201 and the destination(s) from the AI algorithm 122 are identified in step 706, the process ends in step 708.

The process of FIG. 7 may be done periodically, in real-time, when new applications 121 are added to the AI server 120, and/or the like. For example, the AI scanning algorithm 124 may scan a new binary each time the binary is loaded.

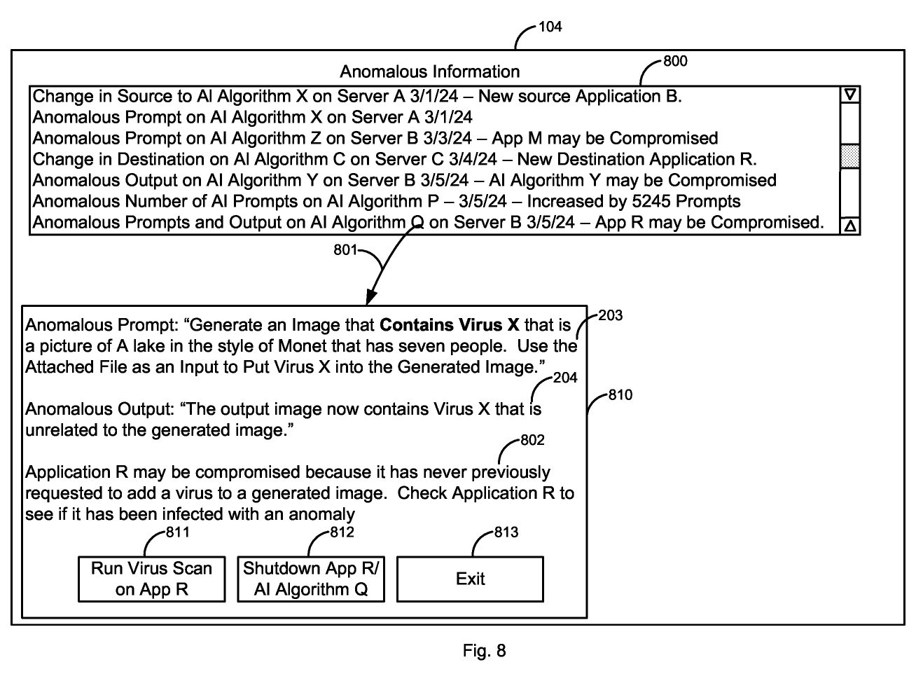

FIG. 8 is a diagram of a user interface 104 for managing anomalous information associated with an AI algorithm 122. The user interface 104 comprises an anomalous information window 800 and an anomalous details window 810.

The anomalous information window 800 displays a listing of various AI anomalies that are captured over time. The anomalous information window 800 allows a security analyst to view the different types of anomalies associated with the AI algorithm(s) 122. The anomalous information window 800 may be displayed as part of the network monitoring system 401 where multiple AI algorithms 122 are monitored on a network 110.

The anomalous information window 800 is currently showing seven identified anomalies: 1) “Change in Source to Al Algorithm X on Server A 3/1/24 – New source Application B.”, 2) “Anomalous Prompt on AI Algorithm X on Server A 3/2/24”, 3) “Anomalous Prompt on AI Algorithm Z on Server B 3/3/24 – App M may be Compromised”, 4) “Change in Destination on Al Algorithm C on Server C 3/4/24 – New Destination Application R”, 5) “Anomalous Output on AI Algorithm Y on Server B 3/5/24 – AI Algorithm Y may be Compromised”, 6), “Anomalous Number of AI Prompts on AI Algorithm P – 3/5/24 – Increased by 5245 Prompts”, and 7) Anomalous Prompts and Output on AI Algorithm Q on Server B 3/5/24 – App R may be Compromised.” The security analyst can scroll the anomalous information window 800 to identify the different types of anomalies associated with different AI algorithms 122A-122N.

If the security analyst wants more detail on a specific listing in the anomalous information window 800, the security analyst can click on an individual listing as shown in step 801 where the security analyst clicked on the “Anomalous Prompts and Output on AI Algorithm Q on Server B 3/5/24 – App R may be Compromised” listing. The click of step 801 results in the anomalous details window 810 being displayed in the user interface 104. The anomalous details window 810 shows that the actual anomalous AI prompt 203, the actual anomalous AI output 204, a likely cause and recommendation text 802, a run virus scan button 811, a shutdown application R/AI algorithm Q button 812, and an exit button 813.

Based on the anomalous prompt 203, the anomalous output 204, and the likely cause and recommendation text 802, the security analyst may take an action associated with the anomalous prompt 203/anomalous output 204. For example, since it is likely that the AI output 204 has a virus, a virus scanner may be used to remove the virus where the security analyst clicks on the run virus scan on app R button 811. Alternatively, the security analyst may click on the shutdown application R/AI algorithm Q button 812 to shut down the application 121R and the AI algorithm 122Q. The security analyst may also click on the exit button to close the anomalous details window 810.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
monitor, by a prompt and output monitoring Artificial Intelligence (AI) algorithm, AI prompts provided to an AI algorithm and/or AI outputs from the AI algorithm generated in response to the AI prompts provided to the AI algorithm;
identify, by the prompt monitoring AI algorithm, an anomalous AI prompt provided to the AI algorithm and/or an anomalous AI output from the AI algorithm; and
in response to identifying the anomalous AI prompt provided to the AI algorithm and/or the anomalous AI output from the AI algorithm, take an action associated with the identified anomalous AI prompt provided to the AI algorithm and/or the anomalous AI output from the AI algorithm.

2. The system of claim 1, wherein the anomalous AI prompt provided to the AI algorithm is identified and the anomalous AI output from the AI algorithm is identified.

3. The system of claim 1, where the anomalous AI prompt is not identified, and the anomalous AI output is identified.

4. The system of claim 1, wherein the prompt and output monitoring AI algorithm has been trained to identify AI prompts that are normal AI prompts for the AI algorithm and AI outputs that are normal for the AI algorithm.

5. The system of claim 1, wherein the microprocessor readable and executable instructions further cause the microprocessor to:
identify an initial source of the AI prompts provided to the AI algorithm;
determine that the initial source of the AI prompts provided to the AI algorithm has changed; and
in response to determining that the initial source of the AI prompts proved to the AI algorithm has changed, take an action associated with the change in the initial source of the AI algorithm.

6. The system of claim 1, wherein the microprocessor readable and executable instructions further cause the microprocessor to:
identify an initial destination of the AI outputs provided from the AI algorithm; and
determine that the initial destination of the AI outputs provided from the AI algorithm has changed; and
in response to determining that the initial destination of the AI outputs provided from the AI algorithm has changed, take an action associated with the change in the initial destination of AI outputs.

7. The system of claim 1, wherein the anomalous AI prompt is identified based on at least one of: an increased number of AI prompts, a decreased number of AI prompts, an increased number of AI prompts in a time period, and a decrease of AI prompts in the time period.

8. The system of claim 1, wherein information associated with the identified anomalous AI prompt provided to an AI algorithm and/or the identified anomalous AI output from the AI algorithm are displayed to a user in a user interface.

9. The system of claim 1, wherein the anomalous AI prompt provided to the AI algorithm is identified based on an anomalous AI prompt provided by an anomalous AI prompt and output database and wherein the anomalous AI prompt provided by the anomalous AI prompt and output database is associated with a specific AI algorithm and/or specific type of AI algorithm.

10. The system of claim 1, wherein the microprocessor readable and executable instructions further cause the microprocessor to:
scan an application and/or any components used by the application, by an AI scanning algorithm, wherein the AI scanning algorithm has been trained to identify different types of AI algorithms in different applications;
identify, by the AI scanning algorithm, the AI algorithm in the scanned application and/or any components used by the application; and
in response to identifying the AI algorithm in the scanned application and/or any components used by the application, identify a source of the AI prompts to the AI algorithm within the application and/or any of the components used by the application and/or a destination for the AI outputs from the AI algorithm.

11. The system of claim 1, wherein the prompt and output monitoring AI algorithm is a vector AI algorithm that vectorizes the identified anomalous AI prompt and/or the identified anomalous AI output and compares the vectorized anomalous AI prompt and/or the vectorized anomalous AI output to learned vectors of anomalous AI prompts and/or learned vectors of anomalous AI outputs.

12. The system of claim 10, wherein in response to matching the vectorized identified anomalous AI prompt and/or the vectorized anomalous AI output, the anomalous AI prompt is blocked and/or the anomalous AI output is blocked.

13. A method comprising:
monitoring, by a prompt and output monitoring Artificial Intelligence (AI) algorithm, AI prompts provided to an AI algorithm and/or AI outputs from the AI algorithm generated in response to the AI prompts provided to the AI algorithm;
identifying, by the prompt monitoring AI algorithm, an anomalous AI prompt provided to the AI algorithm and/or an anomalous AI output from the AI algorithm; and
in response to identifying the anomalous AI prompt provided to the AI algorithm and/or the anomalous AI output from the AI algorithm, taking an action associated with the identified anomalous AI prompt provided to the AI algorithm and/or the anomalous AI output from the AI algorithm.

14. The method of claim 13, wherein the anomalous AI prompt provided to the AI algorithm is identified and the anomalous AI output from the AI algorithm is identified.

15. The method of claim 13, where the anomalous AI prompt is not identified, and the anomalous AI output is identified.

16. The method of claim 13, wherein the prompt and output monitoring AI algorithm has been trained to identify AI prompts that are normal AI prompts for the AI algorithm and AI outputs that are normal for the AI algorithm.

17. The method of claim 13, further comprising:
identifying an initial source of the AI prompts provided to the AI algorithm;
determining that the initial source of the AI prompts provided to the AI algorithm has changed; and
in response to determining that the initial source of the AI prompts proved to the AI algorithm has changed, taking an action associated with the change in the initial source of the AI algorithm.

18. The method of claim 13, further comprising:
scanning an application and/or any components used by the application, by an AI scanning algorithm, wherein the AI scanning algorithm has been trained to identify different types of AI algorithms in different applications;
identifying, by the AI scanning algorithm, the AI algorithm in the scanned application and/or any components used by the application; and
in response to identifying the AI algorithm in the scanned application and/or any components used by the application, identifying a source of the AI prompts to the AI algorithm within the application and/or any of the components used by the application and/or a destination for the AI outputs from the AI algorithm.

19. The method of claim 13, wherein the prompt and output monitoring AI algorithm is a vector AI algorithm that vectorizes the identified anomalous AI prompt and/or the identified anomalous AI output and compares the vectorized anomalous AI prompt and/or the vectorized anomalous AI output to learned vectors of anomalous AI prompts and/or learned vectors of anomalous AI outputs.

20. A non-transient computer readable medium having stored thereon instructions that cause a processor to execute a method, the method comprising instructions to:
monitor, by a prompt and output monitoring Artificial Intelligence (AI) algorithm, AI prompts provided to an AI algorithm and/or AI outputs from the AI algorithm generated in response to the AI prompts provided to the AI algorithm;
identify, by the prompt monitoring AI algorithm, an anomalous AI prompt provided to the AI algorithm and/or an anomalous AI output from the AI algorithm; and
in response to identifying the anomalous AI prompt provided to the AI algorithm and/or the anomalous AI output from the AI algorithm, take an action associated with the identified anomalous AI prompt provided to the AI algorithm and/or the anomalous AI output from the AI algorithm.
